(19) United States
(12) Patent Application Publication
(10) Pub. No.: US 2025/0028490 A1
(43) Pub. Date: Jan. 23, 2025

(54) INFORMATION PROCESSING SYSTEM AND NON-TRANSITORY COMPUTER-READABLE STORAGE MEDIUM STORING INFORMATION PROCESSING PROGRAM

(71) Applicant: FUJIFILM Business Innovation Corp., Tokyo (JP)

(72) Inventors: Hiroyuki TOJO, Kanagawa (JP); Takayuki SAITO, Kanagawa (JP)

(73) Assignee: FUJIFILM Business Innovation Corp., Tokyo (JP)

(21) Appl. No.: 18/585,002

(22) Filed: Feb. 22, 2024

(30) Foreign Application Priority Data
Jul. 18, 2023 (JP) 2023-117091

(51) Int. Cl. G06F 3/12

(52) U.S. Cl. CPC G06F 3/1234; G06F 3/1208; G06F 3/121; G06F 3/1286; G06F 3/1287

(57) ABSTRACT

An information processing system includes at least one processor, wherein when adjustment processing of adjusting image quality of printing by repeating printing and setting of an adjustment value a plurality of times is interrupted during an execution of the adjustment processing, the processor causes a memory to store an interruption adjustment value that is an adjustment value at the time of interruption, and performs the adjustment processing using the interruption adjustment value stored in the memory after a cause of the interruption is eliminated.

### CROSS-REFERENCE TO RELATED APPLICATIONS

This application is based on and claims priority under 35 USC 119 from Japanese Patent Application No. 2023-117091 filed Jul. 18, 2023.

### BACKGROUND

### (i) Technical Field

The present invention relates to an information processing system and a non-transitory computer-readable storage medium storing an information processing program.

### (ii) Related Art

JP2011-259052A shown below discloses an image processing apparatus including an automatic document reading device that automatically conveys a document and read an image of the document, and a memory that temporarily stores document image data obtained by reading the document with the automatic document reading device, the image processing apparatus performing predetermined image processing on the document image data temporarily stored in the memory and outputting the processed data, wherein when a paper jam has occurred when reading with the automatic document reading device and the predetermined image processing on the document image data obtained by the automatic document reading device are performed as a series of processing, the image processing apparatus discards document image data of a page being saved at the time of the paper jam from the memory, obtains document image data by reading the document with the automatic document reading device after the paper jam is resolved while holding document image data of a page immediately preceding the discarded page in the memory, compares the document image data obtained after the paper jam is resolved with the document image data of the immediately preceding page, and in a case where the same page exists, discards as it is, from the memory, data of a page that is the same as or preceding the page and that has already been output among the document image data obtained after the paper jam is resolved and the image data obtained before the paper jam, and excludes the data from the predetermined image processing.

JP3592027B shown below discloses an image processing method for an image processing apparatus including a storage unit capable of storing image data of a plurality of jobs including image data of a job read by an image reading unit and image data of a job output from an external device, and a printing unit capable of printing the image data in the storage unit, wherein when printing work of image data is abnormally stopped due to a factor such as paper jam in the image processing apparatus, a first operation for re-executing printing work of the abnormally stopped job and a second operation for enabling printing work of another job different from the abnormally stopped job without re-executing printing work of the abnormally stopped job can be selectively executed, when the first operation is executed, printing work of the abnormally stopped job can be executed using image data of the abnormally stopped job in the storage unit when the image processing apparatus is ready to re-execute printing work of the abnormally stopped job, and when the second operation is executed, even though the image processing apparatus is ready to re-execute printing work of the abnormally stopped job, printing work of the other job can be re-executed using the storage unit without re-executing printing work of the image data of the abnormally stopped job, and even after printing of the other job has been completed, printing work of the abnormally stopped job can be re-executed using the image data of the abnormally stopped job held in the storage unit.

### SUMMARY

Aspects of non-limiting embodiments of the present disclosure relate to an information processing system and a non-transitory computer-readable storage medium storing an information processing program that can eliminate the need for restarting adjustment processing of adjusting the image quality of printing by repeating printing and setting of an adjustment value a plurality of times from the beginning when the adjustment processing is interrupted during an execution of the adjustment processing.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising at least one processor,
wherein when adjustment processing of adjusting image quality of printing by repeating printing and setting of an adjustment value a plurality of times is interrupted during an execution of the adjustment processing, the processor causes a memory to store an interruption adjustment value that is an adjustment value at the time of interruption, and performs the adjustment processing using the interruption adjustment value stored in the memory after a cause of the interruption is eliminated.

### BRIEF DESCRIPTION OF THE DRAWINGS

Exemplary embodiments of the present invention will be described in detail based on the following figures, wherein:

FIG. 1 is a diagram illustrating a schematic configuration of an information processing system according to a first exemplary embodiment;

FIG. 2 is a block diagram illustrating a hardware configuration of a user terminal used in the information processing system according to the first exemplary embodiment;

FIG. 3 is a block diagram illustrating a hardware configuration of a printer used in the information processing system according to the first exemplary embodiment;

FIG. 4 is a block diagram illustrating an example of a functional configuration of the user terminal;

FIG. 5 is a block diagram illustrating an example of a functional configuration of the printer;

FIG. 6 is a flowchart illustrating a flow of first adjustment processing performed by the printer;

FIG. 7 is a flowchart illustrating a flow of second adjustment processing performed by the printer;

FIG. 8 is a flowchart illustrating a flow of third adjustment processing performed by the printer;

FIG. 9 is a flowchart illustrating a flow of display processing of a list display screen performed by the user terminal;

FIG. 10 is a diagram illustrating an example of a profile list display screen displayed on a display unit of the user terminal;

FIG. 11 is a flowchart illustrating a flow of adjustment start processing after interruption performed by the user terminal when the adjustment processing has been interrupted;

FIG. 12 is a diagram illustrating an example of an edit screen for uncompleted profile displayed on the display unit of the user terminal;

FIG. 13 is a diagram illustrating an example of a display screen displayed on the display unit of the user terminal in a case where a replacement date of a related member is later than an adjustment date of an uncompleted profile;

FIG. 14 is a diagram illustrating an example of a display screen displayed on the display unit of the user terminal in a case where the replacement date of a related member is earlier than the adjustment date of an uncompleted profile;

FIG. 15 is a flowchart illustrating a flow of processing for updating the replacement date of a related member performed by the user terminal;

FIG. 16 is a diagram illustrating a first example of a management screen for a related member displayed on the display unit of the user terminal;

FIG. 17 is a diagram illustrating an example of an inquiry screen for updating the replacement date of a related member displayed on the display unit of the user terminal;

FIG. 18 is a diagram illustrating a second example of the management screen for a related member displayed on the display unit of the user terminal;

FIG. 19 is a flowchart illustrating a flow of processing for assigning a profile to a medium performed by the user terminal; and

FIG. 20 is a diagram illustrating an example of a list display screen of selectable profiles displayed on the display unit of the user terminal.

### DETAILED DESCRIPTION

Hereinafter, an example of the exemplary embodiments of the present invention will be described with reference to the drawings. In the drawings, the same or equivalent components and parts are denoted by the same reference numerals. Dimensional ratios in the drawings are exaggerated for convenience of description and may be different from actual ratios.

### First Exemplary Embodiment

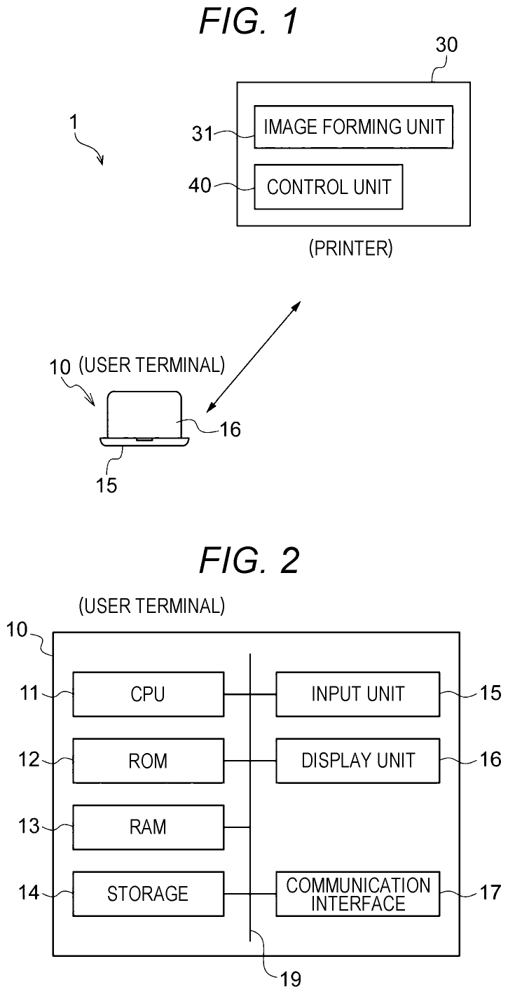

FIG. 1 is a diagram illustrating a schematic configuration of an information processing system according to a first exemplary embodiment.

### (Overall Configuration of Information Processing System)

As illustrated in FIG. 1, an information processing system 1 includes a user terminal 10 and a printer 30 as an example of a printing apparatus. The information processing system 1 is a system in which a user terminal 10 and the printer 30 are connected to each other via the Internet or a wired or wireless network. In FIG. 1, the information processing system 1 is illustrated as a system connected via a wireless network, as an example.

The user terminal 10 is an apparatus that creates print data, gives a print instruction, gives an instruction to perform adjustment processing, and the like. The adjustment processing is processing executed by the printer 30, and the user terminal 10 instructs the printer 30 to execute the adjustment processing. In an example, the adjustment processing is processing for adjusting the image quality of printing by repeating printing and setting of an adjustment value a plurality of times. In an example, the adjustment processing adjusts image quality of printing for each medium (e.g., paper) as an example of a medium. The adjustment processing will be described later.

The user terminal 10 includes an input unit 15 and a display unit 16. For example, print data, a profile as an example of adjustment processing information, and the like are displayed on the display unit 16. In the input unit 15, creation of print data, input of a print instruction, input of an instruction for adjustment processing, and the like are performed.

The printer 30 is an apparatus that performs printing on a recording medium in response to a print instruction from the user terminal 10. The printer 30 receives a print job including print data from the user terminal 10 and forms an image corresponding to the print data included in the print job on a medium (e.g., paper).

In response to an instruction to execute adjustment processing from the user terminal 10, the printer 30 adjusts the image quality of printing by repeating printing on a medium (e.g., paper) and setting of the adjustment value a plurality of times.

The printer 30 includes an image forming unit 31 that forms an image corresponding to print data on a medium (e.g., paper), and a control unit 40 that controls each unit of the printer 30. In an example, the image forming unit 31 is configured to form a color image on a medium (e.g., paper) in four normal colors of cyan, magenta, yellow, and black, but it may be configured to form an image using a specially formulated spot color (e.g., gold, silver, or a fluorescent color) in addition to these normal colors.

In the printer 30, a method of printing on a medium (e.g., paper) is not particularly limited. In an example, the printer 30 is configured to form an image corresponding to print data on a medium (e.g., paper) by an electrophotographic method, but alternatively, for example, it may be of a type of forming an image corresponding to print data on a medium (e.g., paper) by an inkjet method.

### (Hardware Configuration of User Terminal)

FIG. 2 is a block diagram illustrating a hardware configuration of the user terminal 10.

As illustrated in FIG. 2, the user terminal 10 includes each configuration of a central processing unit (CPU) 11, a read only memory (ROM) 12, a random access memory (RAM) 13, a storage 14, an input unit 15, a display unit 16, and a communication interface 17. These configurations are communicably connected to each other via a bus 19.

The CPU 11 is a central processing unit, and executes various programs and controls each unit. The CPU 11 is an example of a processor. That is, the CPU 11 reads a program from the ROM 12 or the storage 14, and executes the program using the RAM 13 as a work area. The CPU 11 controls the above-described configurations and performs various kinds of arithmetic processing in accordance with programs stored in the ROM 12 or the storage 14. In the first exemplary embodiment, an information processing program is stored in the ROM 12 or the storage 14.

The ROM 12 contains therein various programs and various pieces of data. The RAM 13 temporarily stores programs and data therein as a work area. The storage 14 includes a hard disk drive (HDD) or a solid state drive (SSD), and contains various programs including an operating system and various pieces of data. The RAM 13 and the storage 14 are an example of a memory and an example of a second memory.

The display unit 16 is, for example, a liquid crystal display, and it displays various kinds of information. The input unit 15 is used for performing various kinds of input. The input unit 15 includes a pointing device such as a mouse, and a keyboard. The input unit 15 may be of a touch panel type instead of these configurations.

The communication interface 17 is an interface for communicating with other devices such as the printer 30, and for example, a standard such as Ethernet (registered trademark), FDDI, or Wi-Fi (registered trademark) is used.

### (Hardware Configuration of Printer)

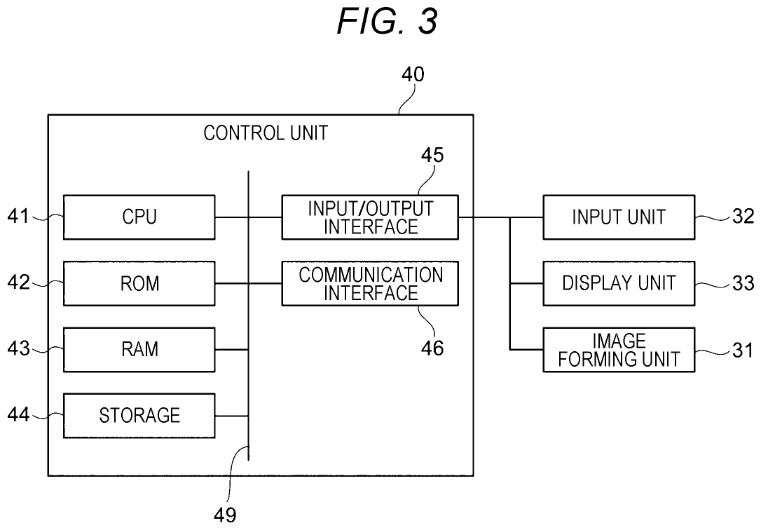

FIG. 3 is a block diagram illustrating a hardware configuration of the printer 30.

As illustrated in FIG. 3, the printer 30 includes a control unit 40, an image forming unit 31, an input unit 32, and a display unit 33. The control unit 40 includes a CPU 41, a ROM 42, a RAM 43, a storage 44, an input/output interface 45, and a communication interface 46. These configurations are communicably connected to each other via a bus 49. The input/output interface 45 is connected to each of the image forming unit 31, the input unit 32, and the display unit 33.

The CPU 41 is a central processing unit, and executes various programs and controls each unit. The CPU 41 is an example of a processor. That is, the CPU 41 reads a program from the ROM 42 or the storage 44, and executes the program using the RAM 43 as a work area. The CPU 41 controls the above-described configurations and performs various kinds of arithmetic processing in accordance with programs stored in the ROM 42 or the storage 44. In the first exemplary embodiment, an information processing program is stored in the ROM 42 or the storage 44.

The ROM 42 contains therein various programs and various pieces of data. The RAM 43 temporarily stores programs and data therein as a work area. The storage 44 includes an HDD or an SSD, and stores various programs including an operating system and various pieces of data. The storage 44 contains a program of a printer driver. The CPU 41 functions as a printer driver by reading the program of the printer driver from the storage 44 and executing the program. The RAM 43 and the storage 44 are an example of a memory and an example of a first memory.

The display unit 33 is, for example, a liquid crystal display, and it displays various kinds of information. The input unit 32 is of a touch panel type, for example, and is used for performing various kinds of input.

### (Functional Configuration of User Terminal)

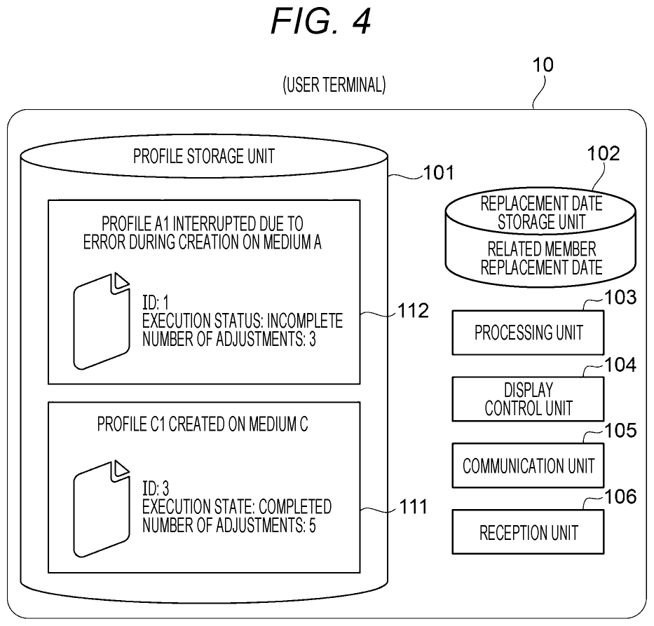

FIG. 4 is a block diagram illustrating an example of a functional configuration of the user terminal 10.

As illustrated in FIG. 4, the user terminal 10 includes, as functional components, a profile storage unit 101, a replacement date storage unit 102, a processing unit 103, a display control unit 104, a communication unit 105, and an acceptance unit 106. Each functional configuration is realized by the CPU 11 reading the information processing program stored in the ROM 12 or the storage 14 and developing and executing the information processing program in the RAM 13.

The profile storage unit 101 has a function of storing a profile as an example of adjustment processing information. The profile storage unit 101 is configured of, for example, the storage 14. When the adjustment processing by the printer 30 has been completed, a profile including identification information for identifying the completed adjustment processing and completion information indicating that the adjustment processing has been completed is stored in the profile storage unit 101. For example, information 111 of a profile C1 created on a medium C (for example, second paper) is stored in the profile storage unit 101. In the information 111 of the profile C1, completion information indicating that an ID as an example of identification information is 3 and an execution state is completed (that is, adjustment processing is completed) and information on the number of adjustments indicating that the number of adjustments is 5 are stored. Here, the ID is a code used to prove identity.

When the adjustment processing is interrupted during an execution of the adjustment processing with the printer 30, the profile storage unit 101 stores a profile including identification information for identifying the adjustment processing that has been interrupted and interruption information indicating that the adjustment processing has been interrupted. For example, the profile storage unit 101 stores information 112 on a profile A1 created on a medium A (e.g., first paper). In the information 112 of the profile A1, interruption information indicating that an ID as an example of identification information is 1 and an execution state is uncompleted (that is, adjustment processing is uncompleted) and information on the number of adjustments indicating that the number of adjustments is 3 are stored.

The replacement date storage unit 102 has a function of storing a replacement date of a related member related to adjustment processing in the printer 30. The replacement date storage unit 102 is configured of, for example, the storage 14. The related member is a replaceable member used in the image forming unit 31 (see FIG. 1) of the printer 30 or the like, and is a member related to the adjustment processing. Although not illustrated, examples of the related member include an electronic cam, a transfer jacket, a belt, and a cleaner blade. In the replacement date storage unit 102, a date and time of replacement of the related member (e.g., year, month, day, and time of replacement) may be stored in accordance with the replacement information of the related member.

The processing unit 103 has a function of performing each processing in the user terminal 10. The processing unit 103 performs, for example, processing of information input from the input unit 15, processing of storing information of a profile, processing of storing a date of replacement of a related member, or processing of instructing an execution of adjustment processing.

In addition, the processing unit 103 may perform processing of deleting the profile corresponding to the related member before replacement according to the replacement information of the related member.

When the adjustment date and time of the profile is earlier than the replacement date and time of the related member, the processing unit 103 does not execute adjustment processing using the adjustment value at the time of interruption corresponding to the profile. That is, when the adjustment date and time of the profile is later than the replacement date and time of the related member, the processing unit 103 executes adjustment processing using the adjustment value at the time of interruption corresponding to the profile.

In addition, the processing unit 103 performs processing of assigning a profile to a medium (e.g., paper).

The display control unit 104 has a function of controlling a screen to be displayed on the display unit 16. The display control unit 104 displays, for example, information on the profile, a date of replacement of the related member (e.g., date and time of replacement), or the like on the display unit 16.

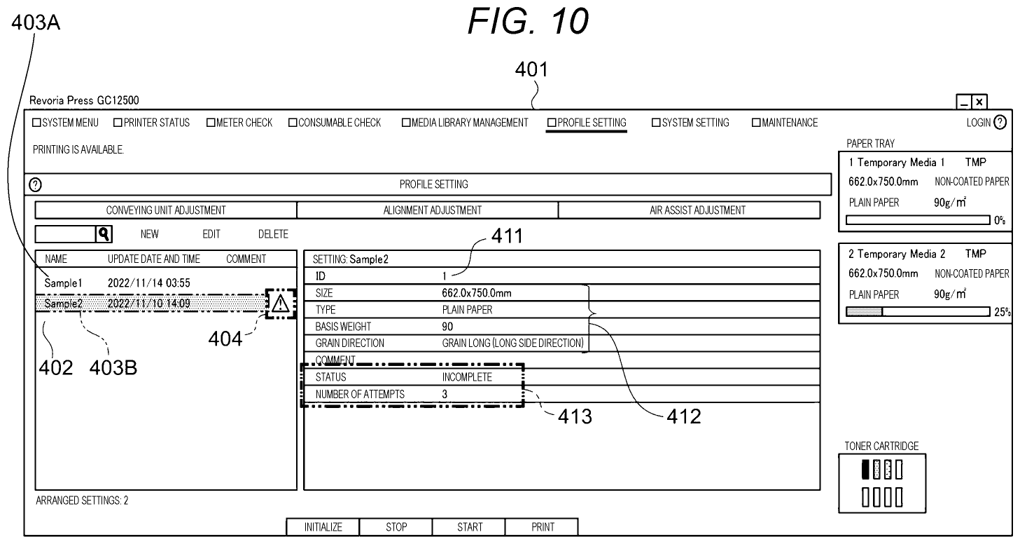

When displaying a profile list display screen on the display unit 16, the display control unit 104 adds a warning symbol to the profile including the interruption information. For example, as illustrated in FIG. 10, when a profile list display screen 401 is displayed on the display unit 16, a warning icon 404, which is an example of a warning symbol, is added to an uncompleted profile 403B for which the adjustment processing has been interrupted during an execution of the adjustment processing. Thus, the profile for which the adjustment processing has been completed and the uncompleted profile for which the adjustment processing has been interrupted during the execution of the adjustment processing are distinguishably displayed.

The display control unit 104 may display, on the display unit 16, information indicating that the adjustment processing using the adjustment value at the time of interruption is not accepted and an execution of the adjustment processing from the beginning is prompted. For example, as illustrated in FIG. 14, the display unit 16 may display a non resumable screen 461 indicating that the adjustment processing using the adjustment value at the time of interruption cannot be resumed and restart of the adjustment processing from the beginning is prompted.

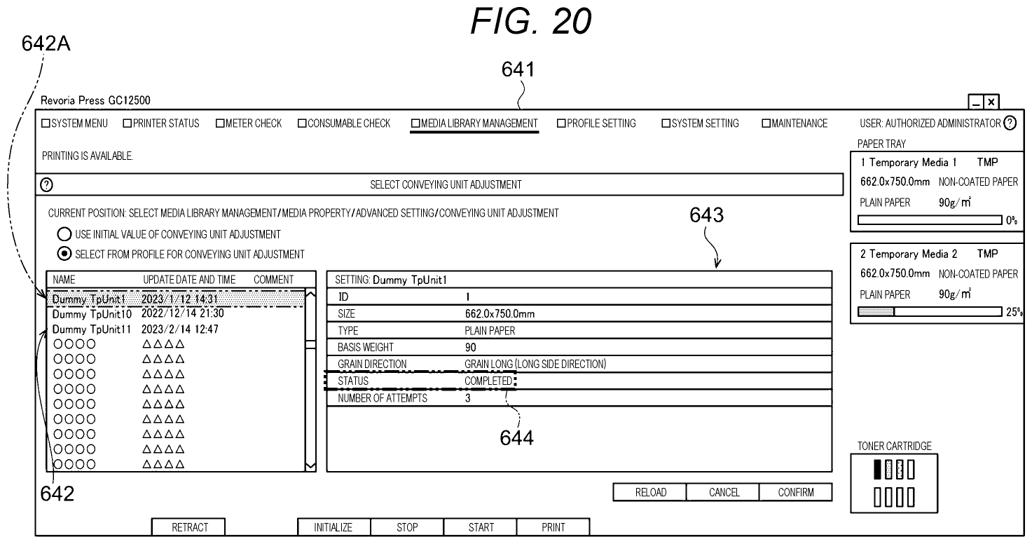

When a profile is assigned to a medium (e.g., paper), the display control unit 104 displays, on the display unit 16, only the profile for which adjustment processing has been completed, on the basis of the contents of the profiles stored in the profile storage unit 101. For example, as illustrated in FIG. 20, an assignment screen 641 on which only a profile 642 for which the adjustment processing has been completed are displayed as a selectable list may be displayed on the display unit 16.

The communication unit 105 has a function of communicating various kinds of information with the printer 30. In an example, the communication unit 105 outputs an instruction to execute adjustment processing to the printer 30. The adjustment processing is thus executed in the printer 30. The communication unit 105 also outputs a print job including print data to the printer 30. An image corresponding to the print data is thus formed on a medium (e.g., paper) by the printer 30.

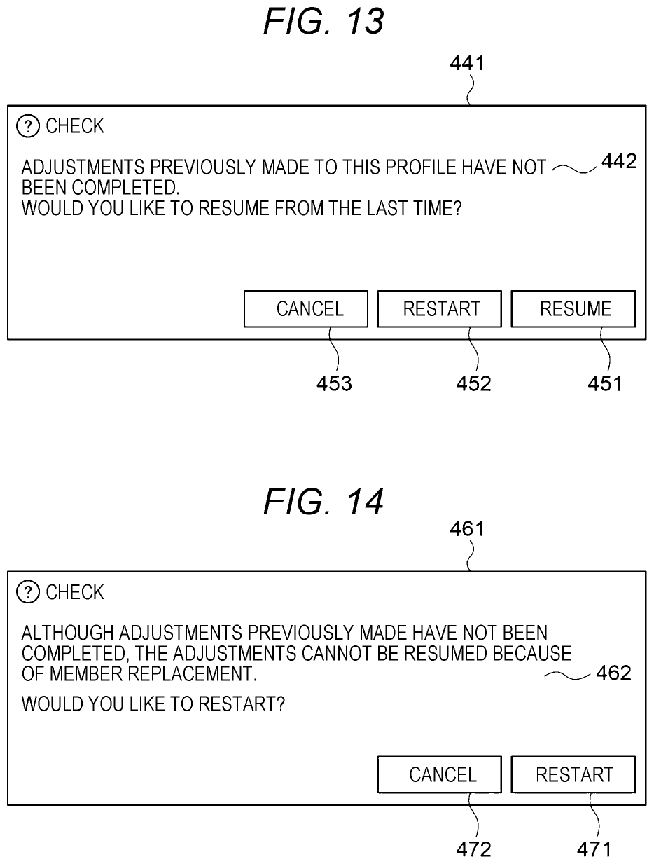

The acceptance unit 106 has a function of accepting selection of whether to execute the adjustment processing using the adjustment value at the time of interruption or to execute the adjustment processing from the beginning when a profile including interruption information (for example, an uncompleted profile) is selected. For example, when an uncompleted profile is selected, as illustrated in FIG. 13, the display unit 16 may display a selection screen 441 for selecting whether to resume the adjustment processing from the last time using the adjustment value at the time of interruption or to restart the adjustment processing from the beginning. For example, when an execution of the adjustment processing using the adjustment value at the time of interruption is selected, the printer 30 readjusts the image quality by resuming the adjustment processing from the last time using the adjustment value at the time of interruption. When an execution of the adjustment processing from the beginning is selected, the printer 30 executes the adjustment processing from the beginning and adjusts the image quality.

For example, when the acceptance unit 106 has accepted a selection to execute the adjustment processing using the adjustment value at the time of interruption, the communication unit 105 outputs an instruction to execute the adjustment processing using the adjustment value at the time of interruption to the printer 30. For example, when the acceptance unit 106 has accepted a selection to execute the adjustment processing from the beginning, the communication unit 105 outputs an instruction to execute the adjustment processing from the beginning to the printer 30.

### (Functional Configuration of Printer)

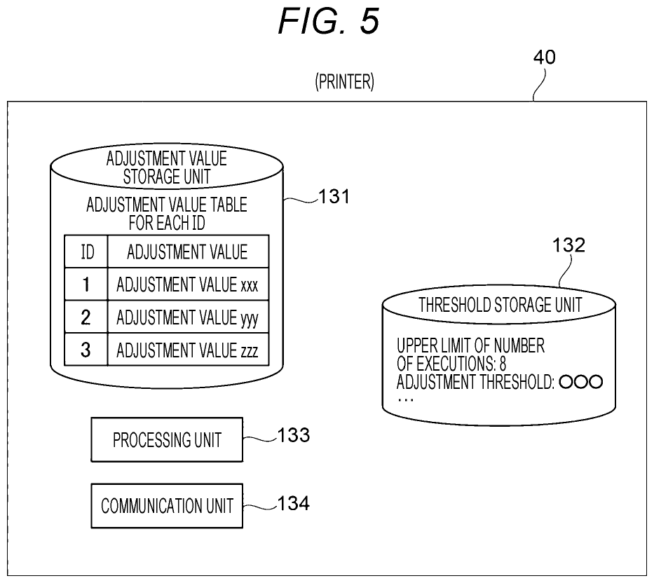

FIG. 5 is a block diagram illustrating an example of a functional configuration of the control unit 40 of the printer 30.

As illustrated in FIG. 5, the control unit 40 of the printer 30 includes, as functional configurations, an adjustment value storage unit 131, a threshold storage unit 132, a processing unit 133, and a communication unit 134. Each functional configuration is realized by the CPU 41 reading the information processing program stored in the ROM 42 or the storage 44 and developing and executing the information processing program in the RAM 43.

The adjustment value storage unit 131 has a function of storing the adjustment value of the adjustment processing. The adjustment value storage unit 131 is configured of, for example, the storage 44. When the adjustment processing by the printer 30 has been completed, the adjustment value after completion as an example of a completion adjustment value is stored in the adjustment value storage unit 131. In an example, the adjustment value after completion is stored in association with the ID as an example of identification information for identifying the adjustment processing. In the first exemplary embodiment, an adjustment value table for each ID is stored in the adjustment value storage unit 131. For example, the ID of the profile C1 for which the adjustment processing has been completed is 3 (see FIG. 4). The adjustment value after completion (e.g., adjustment value zzz) is stored in the adjustment value storage unit 131 in association with ID3.

The adjustment value storage unit 131 stores, when the adjustment processing is interrupted during an execution of the adjustment processing with the printer 30, the adjustment value at the time of interruption (e.g., immediately before interruption of the adjustment processing) as an example of an interruption adjustment value in association with the ID as an example of identification information identifying the adjustment processing that has been interrupted. For example, the ID of the profile A1 for which the adjustment processing is uncompleted is 1 (see FIG. 4). The adjustment value at the time of interruption (e.g., adjustment value xxx) is stored in the adjustment value storage unit 131 in association with the ID1.

The threshold storage unit 132 has a function of storing a threshold for executing the adjustment processing. The threshold storage unit 132 is configured of, for example, the storage 44. In an example, the threshold storage unit 132 stores an upper limit of the number of executions (e.g., eight) as an example of the threshold when the adjustment processing is executed. In an example, the threshold storage unit 132 also stores an adjustment threshold (e.g., a threshold of the misregistration amount of adjustment registration of an electronic cam).

The processing unit 133 has a function of performing various kinds of processing in the printer 30. The processing unit 133 performs an execution of the adjustment processing, processing of storing the adjustment value after completion when the adjustment processing has been completed, processing of storing the adjustment value at the time of interruption when the adjustment processing has been interrupted, or the like. The processing unit 133 also performs processing for updating the replacement date of a related member when the related member related to the adjustment processing is replaced.

Further, the processing unit 133 executes the adjustment processing using the adjustment value at the time of interruption stored in the adjustment value storage unit 131 after the cause of the interruption of the printer 30 is eliminated.

The communication unit 134 has a function of communicating various kinds of information with the user terminal 10. In an example, when the adjustment processing has been interrupted, the communication unit 134 outputs an ID as an example of identification information for identifying the interrupted adjustment processing to the user terminal 10. In an example, when the adjustment processing has been completed, the communication unit 134 outputs an ID as an example of identification information for identifying the completed adjustment processing to the user terminal 10.

### (Operation of First Exemplary Embodiment)

Next, the operation of the information processing system 1 according to the first exemplary embodiment will be described.

### <First to Third Adjustment Processing in Printer>

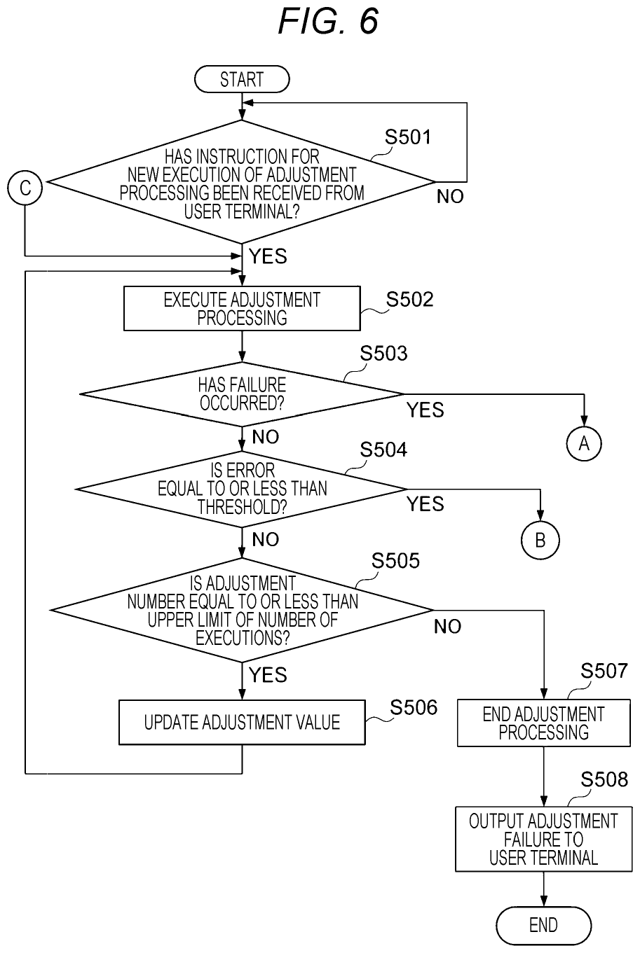

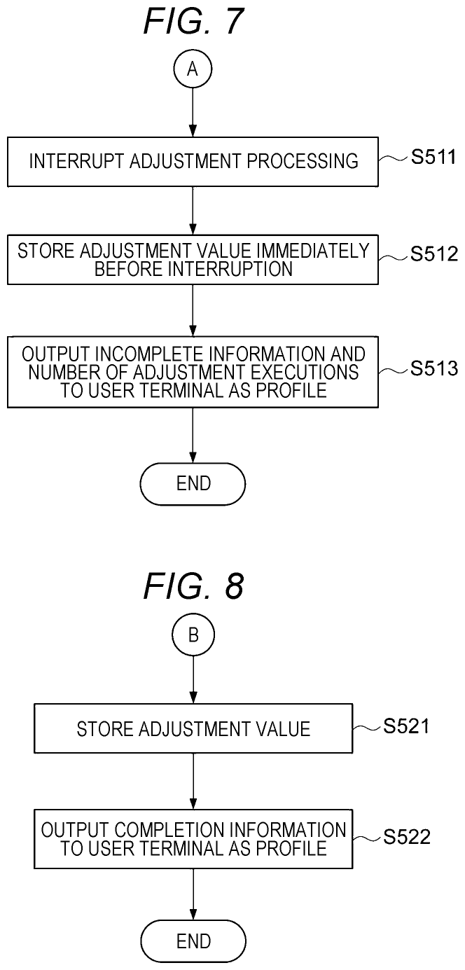

FIG. 6 is a flowchart illustrating a flow of first adjustment processing performed by the printer 30. FIG. 7 is a flowchart illustrating a flow of second adjustment processing performed by the printer 30, and FIG. 8 is a flowchart illustrating a flow of third adjustment processing performed by the printer 30. In the control unit 40 (see FIG. 3) of the printer 30, the CPU 41 reads the adjustment processing program from the ROM 42 or the storage 44, and develops and executes the adjustment processing program in the RAM 43, whereby the adjustment processing is performed.

The CPU 41 determines whether an instruction of new execution of adjustment processing has been accepted from the user terminal 10 (step S501). For example, when an instruction of new execution of adjustment processing is input in the input unit 15 of the user terminal 10, the instruction of new execution of adjustment processing is output from the user terminal 10 to the printer 30. This causes the printer 30 to accept the instruction of new execution of adjustment processing.

When the instruction of new execution of adjustment processing has not been accepted (step S501: NO), the CPU 41 waits until the instruction of new execution of adjustment processing is accepted.

When an instruction of new execution of adjustment processing has been accepted (step S501: YES), the CPU 41 executes the adjustment processing (step S502). For example, in the adjustment processing, in the printer 30, the conveyance speed of a medium (e.g., paper) is maintained at a specified speed, and the image quality of printing is adjusted by repeating printing on the medium (e.g., paper) and setting of the adjustment value of the electronic cam a plurality of times. The electronic cam is a cam that controls conveyance of paper. The adjustment processing may be processing of adjusting the speed of a belt (for example, a transfer belt) instead of the adjustment of the electronic cam.

The CPU 41 determines whether a failure has occurred (step S503). The failure is an error during the operation of the printer 30, and corresponds to, for example, a paper jam or a malfunction of a member in the printer 30. The failure is a reason for interruption of the adjustment processing.

When no failure has occurred (step S503: NO), the CPU 41 determines whether the error in the adjustment value is equal to or less than the threshold (step S504). In an example, the threshold is stored in the threshold storage unit 132 (see FIG. 5). For example, it is determined whether the error (that is, the misregistration amount) of the adjustment value of the electronic cam satisfies a misregistration amount that is a threshold set in advance.

When a failure has occurred (step S503: YES), the CPU 41 proceeds to processing A illustrated in FIG. 7. The processing A will be described later.

When the error of the adjustment value is not equal to or less than the threshold (step S504: NO), the CPU 41 determines whether the number of adjustments is equal to or less than the upper limit of the number of executions (step S505). In an example, the upper limit of the number of executions is stored in the threshold storage unit 132 (see FIG. 5). The upper limit of the number of executions is, for example, eight, and when the number executions of eight is ended, it means that the adjustment has failed.

When the error of the adjustment value is equal to or less than the threshold (step S504: YES), the CPU 41 proceeds to processing B illustrated in FIG. 8. The processing B will be described later.

When the number adjustments is equal to or less than the upper limit of the number of executions (step S505: YES), the CPU 41 updates the adjustment value (step S506). In an example, the adjustment value is stored in the adjustment value storage unit 131 (see FIG. 5).

When the number adjustments is not equal to or less than the upper limit of the number of executions (step S505: NO), the CPU 41 ends the adjustment processing (step S507). The case where the number adjustment is not equal to or less than the upper limit of the number of executions is a case where the number of adjustments exceeds the upper limit of the number of executions, and in this case, the adjustment processing does not continue but ends.

The CPU 41 outputs an adjustment failure to the user terminal 10 (step S508). Although illustration is omitted, information of adjustment failure may be displayed on the display unit 16 of the user terminal 10. The first adjustment processing based on the information processing program performed by the printer 30 than ends.

When a failure has occurred as described above (step S503: YES), the processing proceeds to the processing A illustrated in FIG. 7, and the CPU 41 interrupts the adjustment processing (step S511). That is, the processing A is processing when the adjustment fails.

The CPU 41 stores the adjustment value immediately before interruption (step S512). In an example, the adjustment value immediately before interruption is saved in the adjustment value storage unit 131 (see FIG. 5).

The CPU 41 outputs information of uncompleted profile and the number of adjustment executions to the user terminal 10 (step S513). The second adjustment processing based on the information processing program performed by the printer 30 then ends. Although illustration is omitted, in an example, in the user terminal 10, information on the uncompleted profile (that is, interruption information indicating that the adjustment processing has been interrupted) and the number of adjustment executions are stored in the profile storage unit 101 (see FIG. 4). In an example, information on adjustment failure may be displayed on the display unit 16 of the user terminal 10.

When the errors of the adjustment value are equal to or less than the threshold as described above (step S504: YES), the processing proceeds to the processing B illustrated in FIG. 8, and the CPU 41 stores the adjustment value (step S521). In an example, the adjustment value is stored in the adjustment value storage unit 131 (see FIG. 5). That is, the processing B is processing when the adjustment is successful.

The CPU 41 outputs the information on the completed profile and the number of adjustment executions to the user terminals 10 (step S522). The third adjustment processing based on the information processing program performed by the printer 30 thus ends. Although illustration is omitted, in an example, in the user terminal 10, information on the completed profile (that is, completion information indicating that the adjustment processing has been completed) and the number of adjustment executions is stored in the profile storage unit 101 (see FIG. 4). In one example, information of adjustment completion may be displayed on the display unit 16 of the user terminal 10.

### <Display Processing in User Terminal>

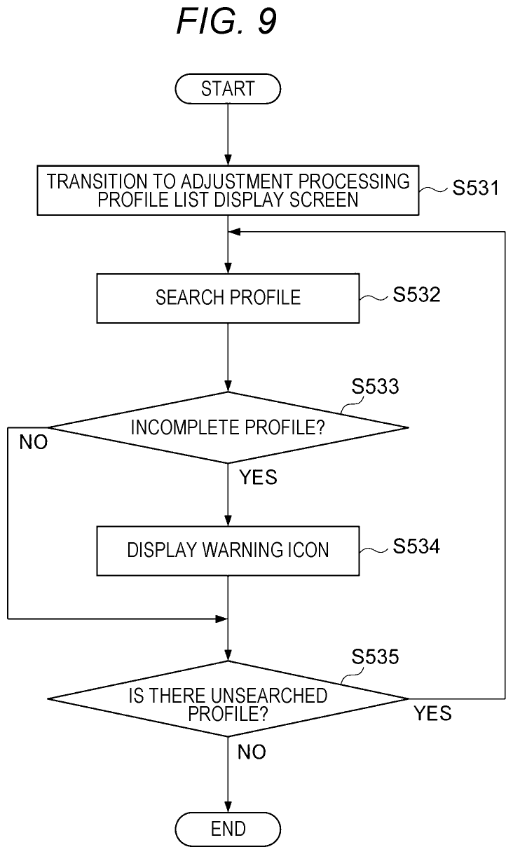

FIG. 9 is a flowchart illustrating a flow of display processing of a list display screen performed by the user terminal 10. In the user terminal 10 (see FIG. 2), the CPU 11 reads the adjustment processing program from the ROM 12 or the storage 14, develops and executes the program in the RAM 13, thereby performing the display processing.

When the profile list display screen is selected, the CPU 11 transitions to a profile list display screen for adjustment processing (step S531). This causes the profile list display screen of the adjustment processing to be displayed on the display unit 16 of the user terminal 10.

The CPU 11 searches for a profile (step S532). In an example, a profile stored in the profile storage unit 101 (see FIG. 4) is searched for.

The CPU 11 determines whether the searched one profile is an uncompleted profile (step S533).

When the searched one profile is an uncompleted profile (step S533: YES), the CPU 11 displays a warning icon on the uncompleted profile (step S534). For example, as illustrated in FIG. 10, profiles 403A and 403B are displayed in a list display area 402 on the list display screen 401 displayed on the display unit 16. The warning icon 404 as an example of the warning symbol is displayed for the uncompleted profile 403B. For example, when the uncompleted profile 403B is selected and displayed, ID information 411, media information 412, and adjustment processing status information 413 are displayed.

The CPU 11 determines whether there is an unsearched profile (step S535). In addition, when the searched one profile is not an uncompleted profile (step S533: NO), the CPU 11 performs the processing in step S535 in the same manner.

When there is an unsearched profile (step S535: YES), the CPU 11 returns to the processing of step S532.

When there is no unsearched profile (step S535: NO), the CPU 11 ends the display processing of the list display screen.

<Adjustment Start Processing after Interruption in User Terminal>

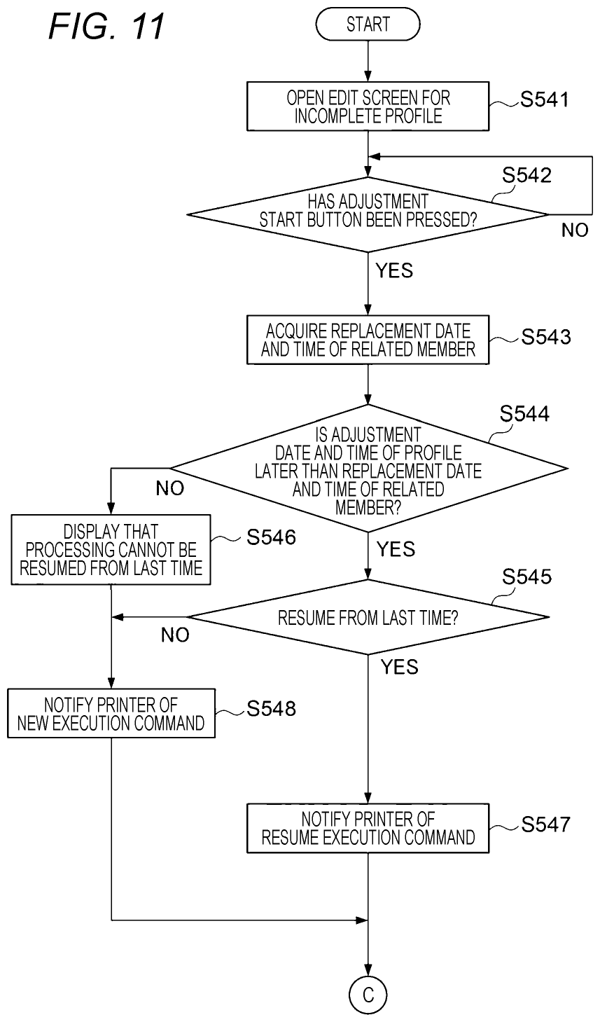

FIG. 11 is a flowchart illustrating a flow of adjustment start processing after interruption performed by the user terminal 10.

In the information processing system 1, when the adjustment processing has been interrupted, adjustment start processing after interruption can be performed from the user terminal 10. In other words, the adjustment start processing after interruption is processing of resuming the interrupted adjustment processing.

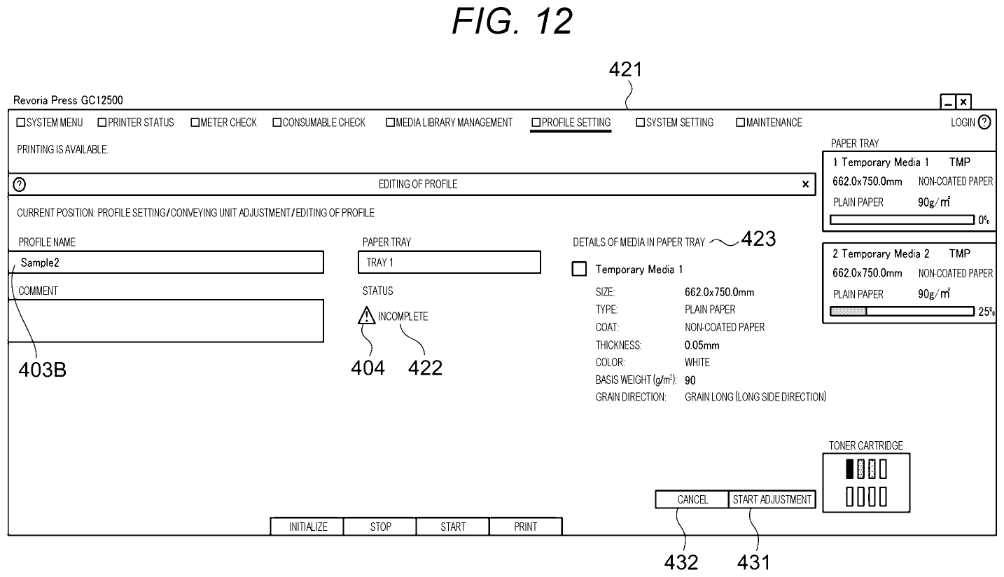

The CPU 11 opens an edit screen for an uncompleted profile (step S541). For example, in a state where the list display screen 401 illustrated in FIG. 10 is displayed on the display unit 16 of the user terminal 10, the user selects an uncompleted profile 403B. This causes an edit screen 421 for the uncompleted profile 403B to be displayed on the display unit 16 as illustrated in FIG. 12. In an example, the warning icon 404 as an example of the warning symbol indicating the uncompleted profile 403B is displayed as processing status information 422 on the edit screen 421. In addition, information 423 of a medium (e.g., paper) is displayed on the edit screen 421. Further, an adjustment start button 431 and a cancel button 432 are displayed on the edit screen 421.

The CPU 11 determines whether the adjustment start button has been pressed (step S542). For example, when the user has pressed the adjustment start button 431 on the edit screen 421 illustrated in FIG. 12, it is determined that the adjustment start button has been pressed.

When the adjustment start button is not pressed (step S542: NO), the CPU 11 waits until the adjustment start button is pressed.

When the adjustment start button has been pressed (step S542: YES), the CPU 11 acquires the replacement date and time of the related member (step S543). In an example, the date and time of replacement of the related member is acquired from the information stored in the replacement date storage unit 102 (see FIG. 4).

The CPU 11 determines whether the adjustment date and time of the profile is later than the replacement date and time of the related member (step S544). The adjustment date and time of the profile is the adjustment date and time when the adjustment processing has been interrupted.

When the adjustment date of the profile is later than the replacement date of the related member (step S544: YES), the CPU 11 determines whether to resume from the time of interruption of the adjustment processing (step S545). Resuming from the time of interruption of the adjustment processing means resuming the adjustment processing from the last time using the adjustment value immediately before interruption of the adjustment processing. As an example, as illustrated in FIG. 13, a start time selection screen 441 is displayed on the display unit 16. Information 442 indicating that the adjustment of the profile is uncompleted is displayed on the selection screen 441. Further, the selection screen 441 displays a resume button 451, a restart button 452, and a cancel button 453. For example, when the user presses the resume button 451, it is determined to resume from the time of interruption of the adjustment processing.

When the adjustment date and time of the profile is not later than the replacement date and time of the related member, that is, when the adjustment date and time of the profile is earlier than the replacement date and time of the associated member (step S544: NO), the CPU 11 displays on the display unit 16 that the processing cannot be resumed from the last time (step S546). When the adjustment date and time of the profile at the time of interruption of the adjustment processing is earlier than the replacement date and time of the related member, the adjustment processing is not allowed to be resumed from the last time to prevent the adjustment processing from being resumed by using the adjustment value immediately before interruption. In an example, as illustrated in FIG. 14, the non resumable screen 461 is displayed on the display unit 16. Information 462 indicating that the adjustment cannot be resumed from the last time, a restart button 471, and a cancel button 472 are displayed on the non resumable screen 461.

When the adjustment processing is resumed from the time of interruption (step S545: YES), the CPU 11 notifies the printer 30 of a resume execution command (step S547). The resume execution command is a command instructing the printer 30 to resume the adjustment processing from the last time. Thereafter, the processing proceeds to processing C and the CPU 41 of the printer 30 executes processing from step S502. More specifically, in the printer 30, the adjustment processing is resumed from the last time (that is, the adjustment processing is resumed from the last time) using the adjustment value immediately before interruption that is stored in the adjustment value storage unit 131.

When the adjustment processing is not resumed from the time of interruption (step S545: NO), the CPU 11 notifies the printer 30 of a new execution command (step S548). The new execution command is a command instructing the printer 30 to restart the adjustment processing from the beginning. Thereafter, the processing proceeds to processing C and the CPU 41 of the printer 30 executes processing from step S502. More specifically, in the printer 30, the adjustment processing restarts from the beginning without using the adjustment value immediately before interruption.

Even after the processing of step S546, the CPU 11 notifies the printer 30 of a new execution command (step S548). In an example, the printer 30 may be notified of the new execution command when the restart button 471 is pressed on the non resumable screen 461 illustrated in FIG. 14.

### <Processing for Updating Replacement Date of Related Member in User Terminal>

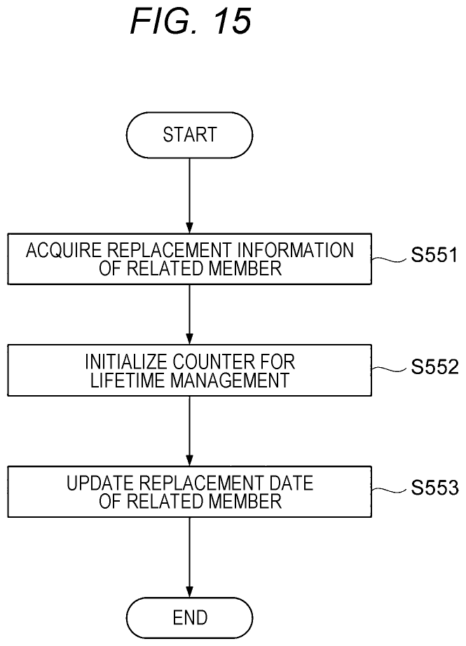

FIG. 15 is a flowchart illustrating a flow of processing for updating the replacement date of a related member performed by the user terminal 10.

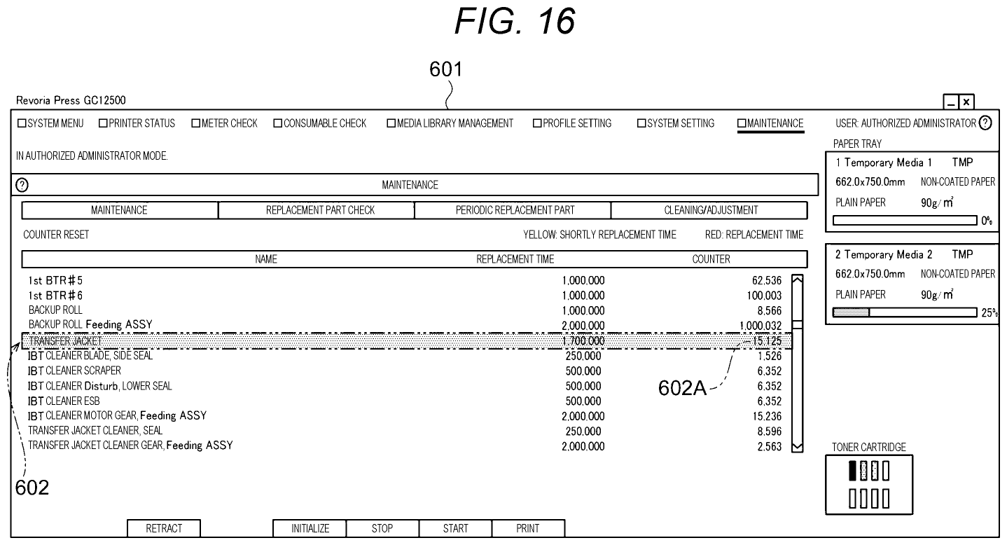

The CPU 11 acquires replacement information on a related member (step S551). For example, when a related member is replaced in the printer 30, replacement information on the related member is output to the user terminal 10, and the replacement information on the related member is received by the user terminal 10. In an example, as illustrated in FIG. 16, maintenance information 601 is displayed on the display unit 16, and when the transfer jacket 602 as an example of the related member is replaced, the transfer jacket 602 is displayed in an identification state (for example, a state in which a color is different) different from other related members. Numerical value information 602A of a counter for lifetime management of the transfer jacket 602 is displayed in the maintenance information 631.

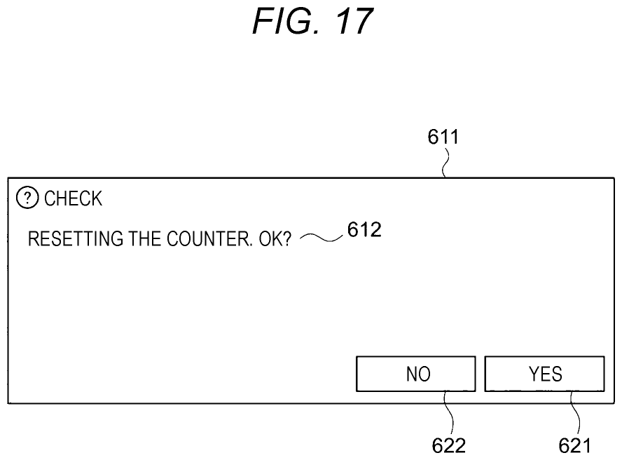

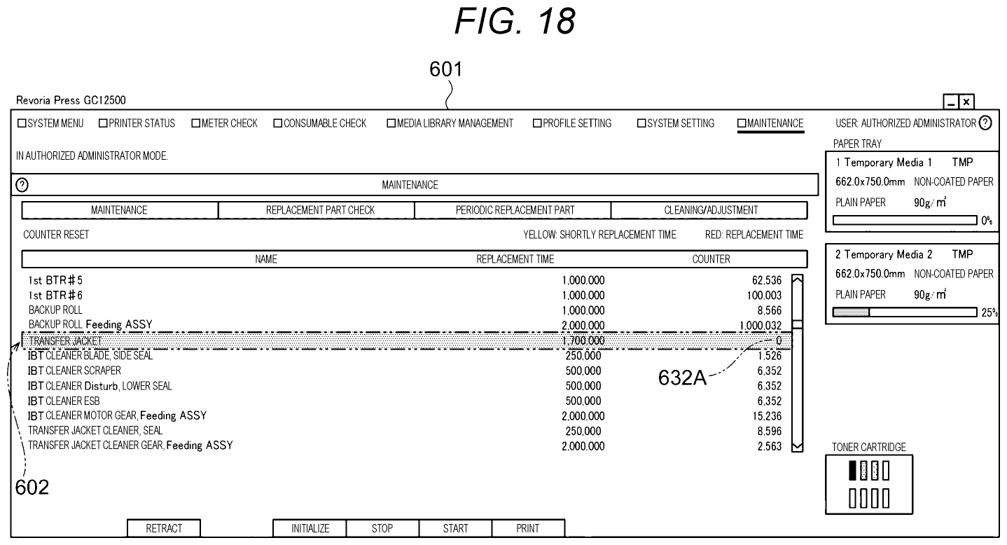

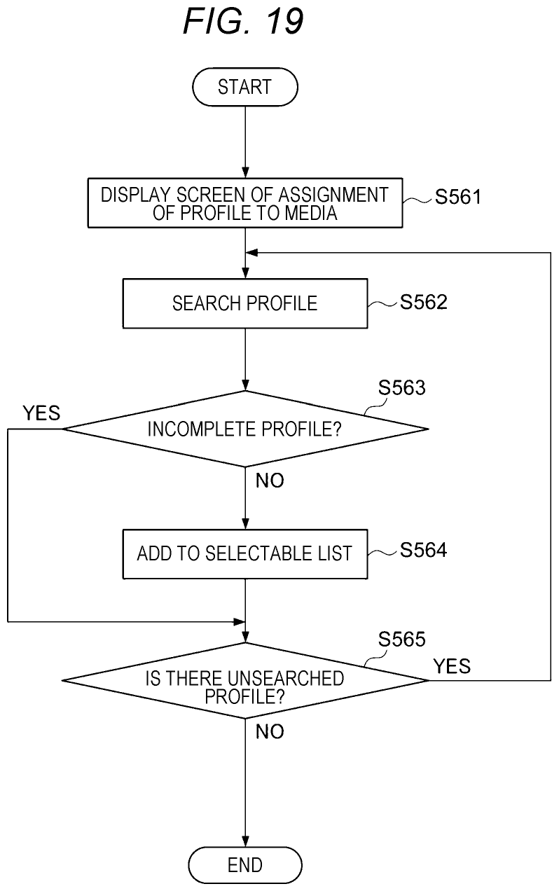

The CPU 11 initializes the counter for lifetime management (step S552). In an example, as illustrated in FIG. 17, a confirmation screen 611 including confirmation information 612 indicating whether the counter for lifetime management can be initialized is displayed on the display unit 16. On the confirmation screen 611, a button 621 for accepting initialization and a button 622 for rejecting initialization are displayed. For example, the counter for lifetime management may be initialized when the user presses the button 621 for accepting initialization on the confirmation screen 611. In an example, as illustrated in FIG. 19, when the counter for lifetime management of the transfer jacket 602 is initialized, numerical value information 632A of the counter for lifetime management becomes “0”.

The CPU 11 updates the date of replacement of the related member (step S553). For example, the date of replacement of the updated related member (e.g., year, month, and date of the update and replacement time) is stored in the replacement date storage unit 102 of the user terminal 10. The update processing of the replacement date of the related member then ends.

### <Processing for Assigning Profile to Medium in User Terminal>

FIG. 19 is a flowchart illustrating a flow of processing for assigning a profile to a medium performed by the user terminal 10.

The CPU 11 displays a screen for assigning a profile to a medium on the display unit 16 (step S561). For example, when display of an assignment screen is instructed by a user's input operation, a screen for assigning a profile to a medium is displayed. The medium includes, for example, information on attributes such as the basis weight and hardness of paper.

The CPU 11 searches for a profile stored in the profile storage unit 101 (see FIG. 4) (step S562).

The CPU 11 determines whether the searched one profile is an uncompleted profile (step S563). For example, a profile for which the adjustment processing has not been completed due to interruption of the adjustment processing is an uncompleted profile.

When the searched one profile is not an uncompleted profile (step S563: NO), the CPU 11 adds the profile to the selectable list (step S564). Thus, the profiles for which the adjustment processing has been completed are displayed in the list.

The CPU 11 determines whether there is an unsearched profile (step S565). In addition, when the searched one profile is an uncompleted profile (step S563: YES), the CPU 11 performs the processing of step S565 in the same manner. Thus, the uncompleted profile is not added to the selectable list.

When there is an unsearched profile (step S565: YES), the CPU 11 returns to the processing of step S562.

When there is no unsearched profile (step S565: NO), the CPU 11 ends the processing for assigning a profile to a medium. In an example, as illustrated in FIG. 20, the assignment screen 641 for assigning to a medium is displayed on the display unit 16. On the assignment screen 641, a plurality of profiles 642 are displayed as a selectable list. At this time, only the profile 642 for which the adjustment processing has been completed is displayed as the selectable list on the assignment screen 641, and the profiles for which the adjustment processing has not been completed are not displayed in the selectable list. For example, when the user selects the first profile 642A from the assignment screen 641, information 643 on the media and the adjustment processing corresponding to the first profile 642A is displayed. This information includes information 644 of completion of the adjustment processing.

In the information processing system 1, when the adjustment processing of adjusting the image quality of printing by repeating printing and setting of the adjustment value a plurality of times is interrupted during an execution of the adjustment processing, the CPU 41 of the printer 30 stores the adjustment value at the time of interruption in the adjustment value storage unit 131. Then, after the cause of the interruption is eliminated, the CPU 41 of the printer 30 executes the adjustment processing by using the adjustment value at the time of interruption stored in the adjustment value storage unit 131. That is, in the present disclosure, the information processing system 1 according to claim 1 can be configured of only the printer 30. Thus, in the information processing system 1, when the adjustment processing of adjusting the image quality of printing by repeating printing and setting of the adjustment value a plurality of times is interrupted during an execution of the adjustment processing, the need for restarting the adjustment processing from the beginning can be eliminated.

In the information processing system 1, the CPU 41 of the printer 30 stores the adjustment value at the time of interruption in the adjustment value storage unit 131 in association with the ID for identifying the adjustment processing that has been interrupted. The CPU 11 of the user terminal 10 causes the profile storage unit 101 to store a profile including the ID for identifying the adjustment processing that has been interrupted and interruption information indicating that the adjustment processing has been interrupted. Thus, in the information processing system 1, it is possible to execute the adjustment processing from the middle using the adjustment value at the time of interruption corresponding to the profile according to the instruction from the user terminal 10 including the profile storage unit 101.

In the information processing system 1, when the adjustment processing has been completed, the CPU 41 of the printer 30 causes the adjustment value storage unit 131 to store the adjustment value after completion. The CPU 11 of the user terminal 10 causes the profile storage unit 101 to store a profile including the ID for identifying the adjustment processing that has been completed and completion information indicating that the adjustment processing has been completed. Thus, in the information processing system 1, it is possible to execute printing with the printer 30 using the adjustment value after completion corresponding to the profile according to the instruction from the user terminal 10 including the profile storage unit 101.

In addition, in the information processing system 1, when a profile including interruption information (that is, an uncompleted profile) is selected in the user terminal 10, the CPU 11 of the user terminal 10 accepts a selection as to whether to readjust the image quality by performing adjustment processing using the adjustment value at the time of interruption or to adjust the image quality by executing the adjustment processing from the beginning (see FIG. 13). Thus, in the information processing system 1, optimum adjustment processing can be performed according to the user's intention as compared with a case where only adjustment processing of readjusting with the adjustment value at the time of interruption is performed when a profile including the ID at the time of interruption and interruption information is selected.

Further, in the information processing system 1, when a related member related to the adjustment processing is replaced in the printer 30, the CPU 11 of the user terminal 10 causes the replacement date storage unit 102 to store the replacement date and time of the related member according to the replacement information of the related member. Thus, in the information processing system 1, a profile for which the adjustment processing has been performed before the related member is replaced is prevented from being erroneously used, as compared with a case where only the fact that the related member has been replaced is saved.

Further, in the information processing system 1, when the adjustment date and time of the profile is earlier than the replacement date and time of the related member, the CPU 11 of the user terminal 10 does not execute adjustment processing using the adjustment value at the time of interruption corresponding to the profile. Thus, in the information processing system 1, when the adjustment date and time of the profile is earlier than the replacement date and time of the related member, the execution of adjustment processing using the adjustment value at the time of interruption corresponding to the profile is prevented.

Further, in the information processing system 1, when the adjustment date and time of the profile is earlier than the replacement date and time of the related member, the CPU 11 of the user terminal 10 displays, on the display unit 16, information indicating that the adjustment processing using the adjustment value at the time of interruption is not accepted and an execution of the adjustment processing from the beginning is prompted (see FIG. 14). Thus, in the information processing system 1, when the adjustment date and time of the profile is earlier than the replacement date and time of the related member, adjustment processing can be executed from the beginning.

Further, in the information processing system 1, the CPU 11 of the user terminal 10 may delete the profile corresponding to the related member before replacement in response to the replacement information on the related member. For example, when the adjustment date and time of the adjustment processing information is earlier than the replacement date and time of the related member, the profile corresponding to the related member before the replacement is deleted. Thus, in the information processing system 1, when the adjustment date and time of the adjustment processing information is earlier than the replacement date and time of the related member, an execution of adjustment processing using the adjustment value at the time of interruption corresponding to the profile of the related member before the replacement is prevented.

Further, in the information processing system 1, when the CPU 11 of the user terminal 10 displays the profile list display screen on the display unit 16, the warning icon 404 is added to the profile including the interruption information (that is, the uncompleted profile) and displayed (see FIG. 10). Thus, in the information processing system 1, it is easy to identify the profile for which the adjustment processing has been interrupted on the list display screen, as compared to a case where only the profile is displayed on the list display screen without adding the warning symbol.

Further, in the information processing system 1, when the CPU 11 of the user terminal 10 assigns a profile to a medium, only the profile for which adjustment processing has been completed is displayed on the display unit 16 based on the contents of the profile stored in the profile storage unit 101 (see FIG. 20). Thus, in the information processing system 1, when a profile is assigned to a medium, erroneous selection of the interrupted profile is prevented as compared to a case where a profile for which the adjustment processing has been interrupted is displayed.

Further, when the adjustment processing of adjusting the image quality of printing by repeating printing and setting of the adjustment value a plurality of times is interrupted during an execution of the adjustment processing, the information processing program causes a computer to store the adjustment value at the time of interruption in the adjustment value storage unit 131 and to execute processing for performing adjustment processing by using the adjustment value at the time of interruption held in the adjustment value storage unit 131 after the cause of the interruption is eliminated. Thus, in the information processing program, when the adjustment processing of adjusting the image quality of printing by repeating printing and setting of the adjustment value a plurality of times is interrupted during an execution of the adjustment processing, the need for restarting the adjustment processing from the beginning can be eliminated.

### [Others]

In the information processing system 1 of the above-described exemplary embodiments, the user terminal 10 and the printer 30 are wirelessly connected, but the present disclosure is not limited to this configuration. For example, the user terminal 10 and the printer 30 may be configured to be connected by wire. Further, for example, the user terminal 10 and the printer 30 may be configured to be connected in a wired or wireless manner via a relay device such as a server.

Although the user terminal 10 and the printer 30 are separate devices in the above-described information processing system 1, the present disclosure is not limited to this configuration. For example, in the information processing system including an image forming unit, when the adjustment processing has been interrupted, the adjustment value at the time of interruption may be stored in the memory, and after the cause of the interruption is eliminated, the adjustment processing may be executed using the adjustment value at the time of interruption stored in the memory.

In the above-described information processing system 1, the processing of the user terminal 10 and the printer 30 may also be realized by dedicated hardware circuits. In this case, the processing may be executed by one piece of hardware or may be executed by a plurality of pieces of hardware.

In the information processing system 1, the program for operating the user terminal 10 and the printer 30 may be provided by a computer-readable recording medium such as a universal serial bus (USB) memory, a flexible disk, or a compact disc read only memory (CD-ROM), or may be provided online via a network such as the Internet. In this case, the program recorded on the computer-readable recording medium is normally transferred to and stored in a memory, a storage, or the like. Further, for example, this program may be provided as independent application software, or may be incorporated, as one function of the user terminal 10 and the printer 30, into software of each of the devices.

Although the present invention has been described in detail with reference to specific exemplary embodiments, the present invention is not limited to such exemplary embodiments, and it is apparent to those skilled in the art that various other exemplary embodiments are possible within the scope of the present invention.

### [Preferable Aspects of the Present Disclosure]

Hereinafter, preferable aspects of the present disclosure will be supplementarily noted.

(((1)))

An information processing system comprising at least one processor,
wherein when adjustment processing of adjusting image quality of printing by repeating printing and setting of an adjustment value a plurality of times is interrupted during an execution of the adjustment processing, the processor causes a memory to store an interruption adjustment value that is an adjustment value at the time of interruption, and performs the adjustment processing using the interruption adjustment value stored in the memory after a cause of the interruption is eliminated.
   (((2)))

The information processing system according to (((1))), wherein
the memory includes a first memory included in a printing apparatus that executes the adjustment processing and a second memory included in a user terminal that can instruct the printing apparatus to execute the adjustment processing, and the processor causes the first memory included in the printing apparatus that executes the adjustment processing to store the interruption adjustment value in association with identification information for identifying the adjustment processing that has been interrupted, and causes the second memory included in the user terminal that can instruct the printing apparatus to execute the adjustment processing to store adjustment processing information including the identification information for identifying the adjustment processing that has been interrupted and interruption information indicating that the adjustment processing has been interrupted.
   (((3)))

The information processing system according to (((2))), wherein
when the adjustment processing has been completed, the processor causes the first memory to store a completion adjustment value that is an adjustment value after completion, and causes the second memory to store adjustment processing information including identification information for identifying the adjustment processing that has been completed and completion information indicating that the adjustment processing has been completed.
   (((4)))

The information processing system according to (((1))) or (((2))), wherein
when the adjustment processing information including the interruption information is selected in the user terminal, the processor accepts a selection as to whether to readjust the image quality by performing the adjustment processing using the interruption adjustment value or to adjust the image quality by executing the adjustment processing from the beginning.
   (((5)))

The information processing system according to (((2))), wherein
when a related member related to the adjustment processing is replaced in the printing apparatus, the processor causes the second memory to store a replacement date and time of the related member according to replacement information of the related member.
   (((6)))

The information processing system according to (((5))), wherein
when the adjustment date and time of the adjustment processing information is earlier than the replacement date and time, the processor does not execute the adjustment processing using the interruption adjustment value corresponding to the adjustment processing information.
   (((7)))

The information processing system according to (((6))), wherein
when the adjustment date and time of the adjustment processing information is earlier than the replacement date and time, the processor displays, on a display unit of the user terminal, information indicating that the adjustment processing using the interruption adjustment value is not accepted and an execution of the adjustment processing from the beginning is prompted.
   (((8)))

The information processing system according to (((5))) or (((6))), wherein
the processor deletes, according to replacement information of the related member, the adjustment processing information corresponding to the related member before replacement from the memory.
   (((9)))

The information processing system according to any one of (((2))) to (((8))), wherein
the processor displays, on a display unit of the user terminal, the adjustment processing information including the interruption information in a selectable manner.
   (((10)))

The information processing system according to (((9))), wherein
when displaying a list display screen of the adjustment processing information on the display unit of the user terminal, the processor adds a warning symbol to the adjustment processing information including the interruption information and displays the adjustment processing information.
   (((11)))

The information processing system according to (((2))), wherein
when the adjustment processing information is assigned to a medium, the processor displays, based on a content of the adjustment processing information stored in the second memory, only the adjustment processing information for which the adjustment processing has been completed on a display unit of the user terminal.
   (((12)))

A non-transitory computer-readable storage medium storing an information processing program that causes a computer to execute processing of, when adjustment processing of adjusting image quality of printing by repeating printing and setting of an adjustment value a plurality of times is interrupted during an execution of the adjustment processing, causing a memory to store an interruption adjustment value that is an adjustment value at the time of interruption, and performing the adjustment processing using the interruption adjustment value stored in the memory after a cause of the interruption is eliminated.

What is claimed is:

1. An information processing system comprising at least one processor,
wherein when adjustment processing of adjusting image quality of printing by repeating printing and setting of an adjustment value a plurality of times is interrupted during an execution of the adjustment processing, the processor causes a memory to store an interruption adjustment value that is an adjustment value at the time of interruption, and performs the adjustment processing using the interruption adjustment value stored in the memory after a cause of the interruption is eliminated.

2. The information processing system according to claim 1, wherein
the memory includes a first memory included in a printing apparatus that executes the adjustment processing and a second memory included in a user terminal that can instruct the printing apparatus to execute the adjustment processing, and the processor causes the first memory included in the printing apparatus that executes the adjustment processing to store the interruption adjustment value in association with identification information for identifying the adjustment processing that has been interrupted, and causes the second memory included in the user terminal that can instruct the printing apparatus to execute the adjustment processing to store adjustment processing information including the identification information for identifying the adjustment processing that has been interrupted and interruption information indicating that the adjustment processing has been interrupted.

3. The information processing system according to claim 2, wherein
when the adjustment processing has been completed, the processor causes the first memory to store a completion adjustment value that is an adjustment value after completion, and causes the second memory to store adjustment processing information including identification information for identifying the adjustment processing that has been completed and completion information indicating that the adjustment processing has been completed.

4. The information processing system according to claim 2, wherein
when the adjustment processing information including the interruption information is selected in the user terminal, the processor accepts a selection as to whether to readjust the image quality by performing the adjustment processing using the interruption adjustment value or to adjust the image quality by executing the adjustment processing from the beginning.

5. The information processing system according to claim 2, wherein
when a related member related to the adjustment processing is replaced in the printing apparatus, the processor causes the second memory to store a replacement date and time of the related member according to replacement information of the related member.

6. The information processing system according to claim 5, wherein
when the adjustment date and time of the adjustment processing information is earlier than the replacement date and time, the processor does not execute the adjustment processing using the interruption adjustment value corresponding to the adjustment processing information.

7. The information processing system according to claim 6, wherein
when the adjustment date and time of the adjustment processing information is earlier than the replacement date and time, the processor displays, on a display unit of the user terminal, information indicating that the adjustment processing using the interruption adjustment value is not accepted and an execution of the adjustment processing from the beginning is prompted.

8. The information processing system according to claim 5, wherein
the processor deletes, according to replacement information of the related member, the adjustment processing information corresponding to the related member before replacement from the memory.

9. The information processing system according to claim 4, wherein
the processor displays, on a display unit of the user terminal, the adjustment processing information including the interruption information in a selectable manner.

10. The information processing system according to claim 9, wherein
when displaying a list display screen of the adjustment processing information on the display unit of the user terminal, the processor adds a warning symbol to the adjustment processing information including the interruption information and displays the adjustment processing information.

11. The information processing system according to claim 2, wherein
when the adjustment processing information is assigned to a medium, the processor displays, based on a content of the adjustment processing information stored in the second memory, only the adjustment processing information for which the adjustment processing has been completed on a display unit of the user terminal.

12. A non-transitory computer-readable storage medium storing an information processing program that causes a computer to execute processing of, when adjustment processing of adjusting image quality of printing by repeating printing and setting of an adjustment value a plurality of times is interrupted during an execution of the adjustment processing, causing a memory to store an interruption adjustment value that is an adjustment value at the time of interruption, and performing the adjustment processing using the interruption adjustment value stored in the memory after a cause of the interruption is eliminated.
